(19) United States
(12) Patent Application Publication
(10) Pub. No.: US 2005/0164816 A1
(43) Pub. Date: Jul. 28, 2005

(54) Chain connecting device

(76) Inventor: Wen-pin Wang, Tainan Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/763,322

(22) Filed: Jan. 26, 2004

(51) Int. Cl. F16G 13/02

(52) U.S. Cl. 474/234; 474/231; 474/228

(57) ABSTRACT

A chain connecting device includes a roller, a pair of inner chain plates, a pair of outer chain plates, a rivet and a fastener. The rivet has a hole at one end with inner threads for the fastener to be threaded therein. Both the rivet and the fastener each comprise an enlarged end to hold the inner chain plates and the outer chain plates together in a secure manner and to enhance the strength of the connection.

### FIELD OF THE INVENTION

This invention relates to a chain connecting device, and more particularly to a rivet and a fastener both formed with an enlarged section to hold the inner chain plates, the outer chain plates and the roller. This design is suitable to a bicycle with multiple chain plates and is reliable and can be reused for numerous times.

### BACKGROUND OF THE INVENTION

A conventional bicycle chain structure uses a pair of outer chain plates B1 connected to a pair of inner chain plates B2 with a washer B3 and a roller B4 secured between the outer chain plates B1 and the inner chain plates B2 and secured by a rivet B5. By repeating these steps, a complete chain will be formed, as shown in FIG. 8.

However, when installing the chain on to a bicycle, a user needs to readjust the length of the chain by cutting and reconnecting the chain. In some events, this procedure damages the chain and cannot connect as the original design and may easily get loose or break.

FIG. 9 shows another prior chain, which forms a neck C2 on one end of a rivet C1. The length of two holes C4 of a chain tension C3 are smaller than the length of two adjacent rivets C1. Thus the connection is tight and may be adjustable. This design is for a multiple-speed bicycle. The more speed it has, the more chain plates are adapted. However, chains are limited to its width. The more chain plates are adapted, the more narrow chain will be in order to install more chain plates. Thus, the chain can sustain less strength.

### SUMMARY OF THE INVENTION

It is the primary object of the present invention to provide a chain connecting device, which is more solid and lasts longer.

It is another object of the present invention to provide a chain connecting device, which is easy to install and disengage.

It is a further object of the present invention to provide a chain connecting device, which length is easy to adjust and may be reused.

### BRIEF DESCRIPTION OF THE DRAWINGS

FIG. 1 is an exploded view of a first embodiment of the present invention;

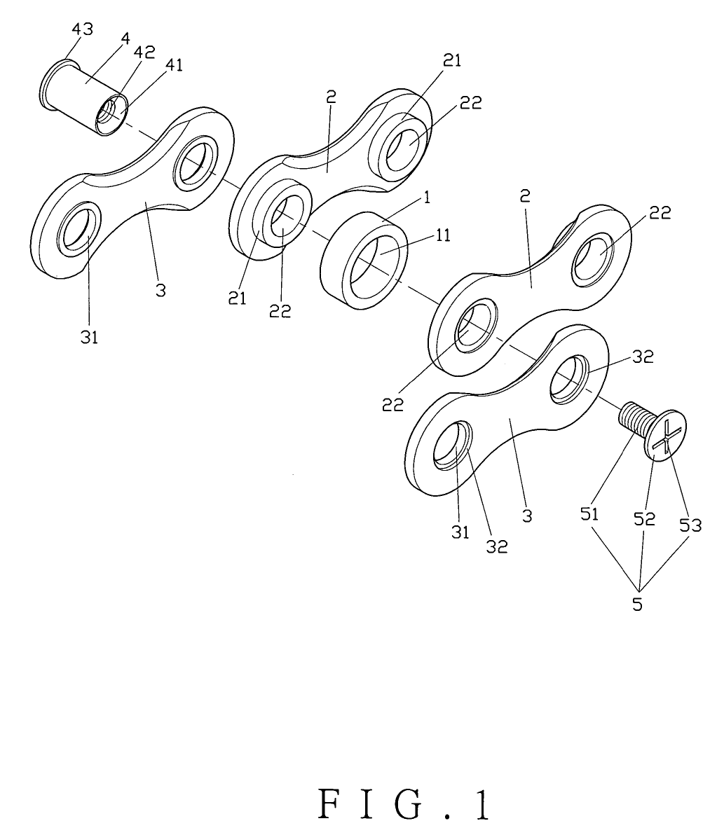

FIG. 2 is a side view of the first embodiment of the present invention, partially sectioned;

FIG. 3 is a cross-sectional view of a second embodiment of the present invention;

FIG. 4 is a cross-sectional view showing that a stud is applied to the second embodiment of the present invention;

FIG. 5 a cross-sectional view showing that the stud is inserted into a through hole of the second embodiment of the present invention;

FIG. 6 is cross-sectional view of the assembly of the second embodiment of the present invention;

FIG. 7 is cross-sectional view of a third embodiment of the present invention;

FIG. 8 is a side sectional view of a prior art, and

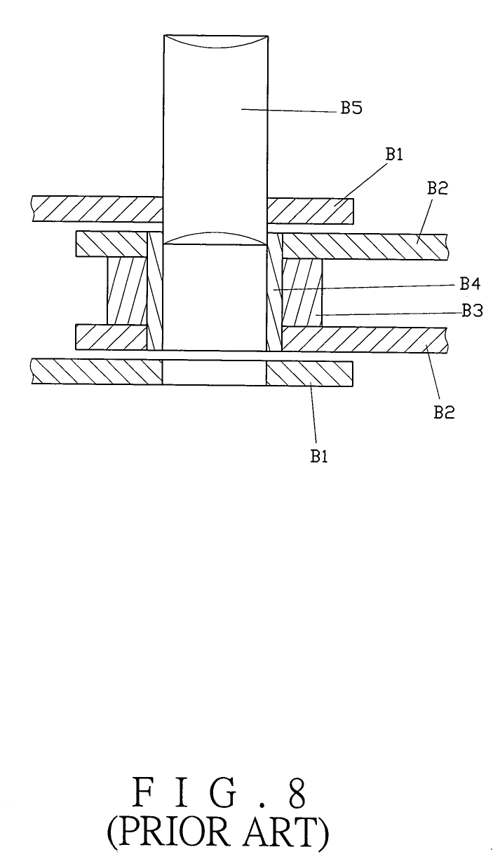

FIG. 9 is a side sectional view of a second prior art.

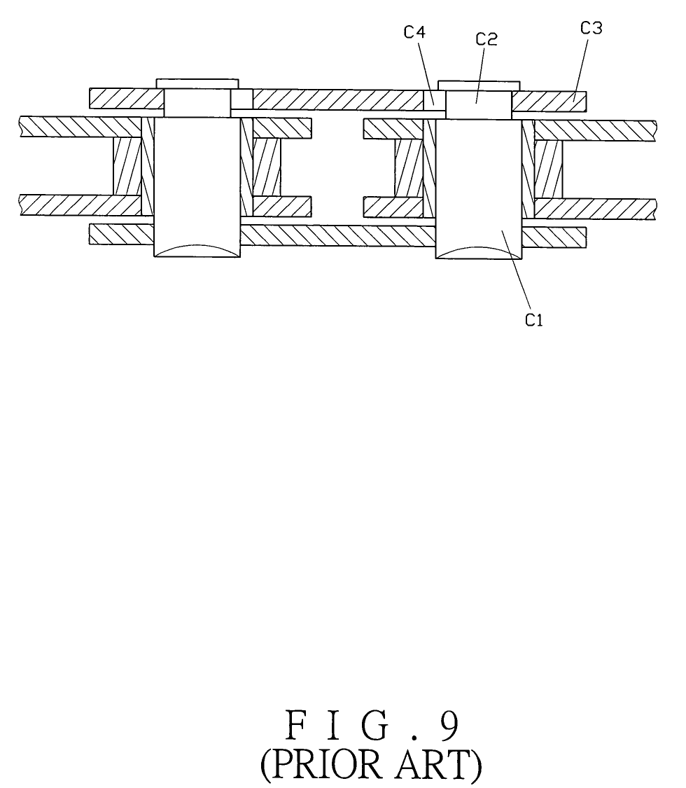

### DETAILED DESCRIPTION OF THE PREFERRED EMBODIMENT

The present invention comprises a roller 1, a pair of inner chain plates 2, a pair of outer chain plates 3, a rivet 4, and a fastener 5.

The roller 1 has a hole 11.

The inner chain plates 2 are pivoted to two ends of the roller 1. Each inner chain plate 2 comprises a pair of bosses 21. Each boss 21 has a hole 22 thereof.

The outer chain plates 3 are adapted to connect with the inner chain plates 2 from outside thereof. Each outer chain plate 3 comprises a pair of holes 31 at respective ends. Each hole 31 has an enlarged section 32 on the outer edge.

The rivet 4 is inserted through the hole 11 of the roller 1, the holes 21 of the inner chain plates 2 and the holes 31 of the outer chain plates 3. The rivet 4 has an outer diameter that is slightly larger than the inner diameters of the hole 11 of the roller 1, the holes 21 of the inner chain plates 2, and the holes 31 of the outer chain plates 3. The rivet 4 has a hollow body with a reversed cone shape blind hole 41 at one end, with inner threads 42 therein. The rivet 4 has a tab 43 at the other end.

The fastener 5 has a shank 51 with threads to be threaded into the blind hole 42 of the rivet 4. The fastener 5 also has a tab 52 with cross cut 53 on the top end. The shank 51 is applied with antiskid material.

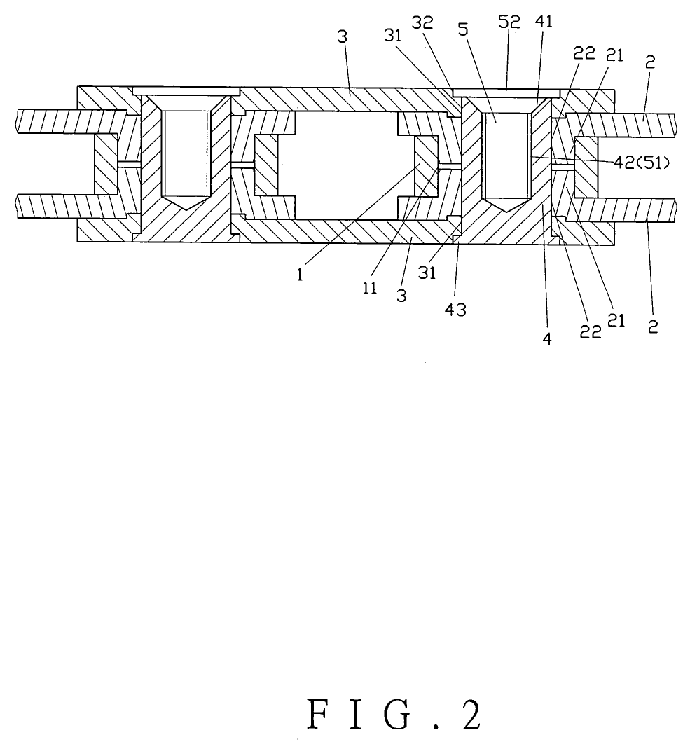

To assemble the present invention, as shown in FIG. 2, the bosses 21 on the inner chain plates 2 are inserted into the roller 1, respectively, and then the outer chain plates 3 are placed on the inner chain plates 2 with the holes 31 facing the holes 21 and the fastener 5 is pressed into the holes 31, 21 and 11 and thread into the blind hole 41 of the rivet 4 in a secure manner, whereas the tab 52 of the fastener 5 and the tab 43 of the rivet 4 will be sunk into the enlarged sections 32 of the outer chain plates 3. By repeating these steps, a complete chain will be formed.

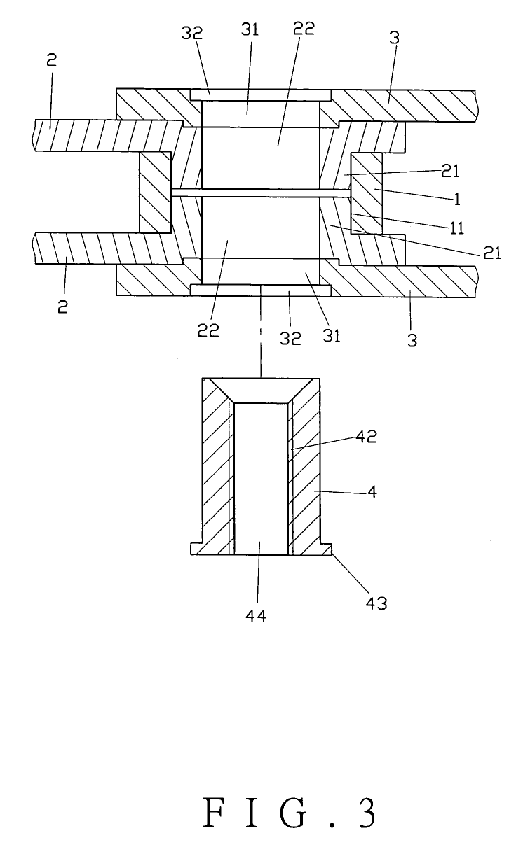

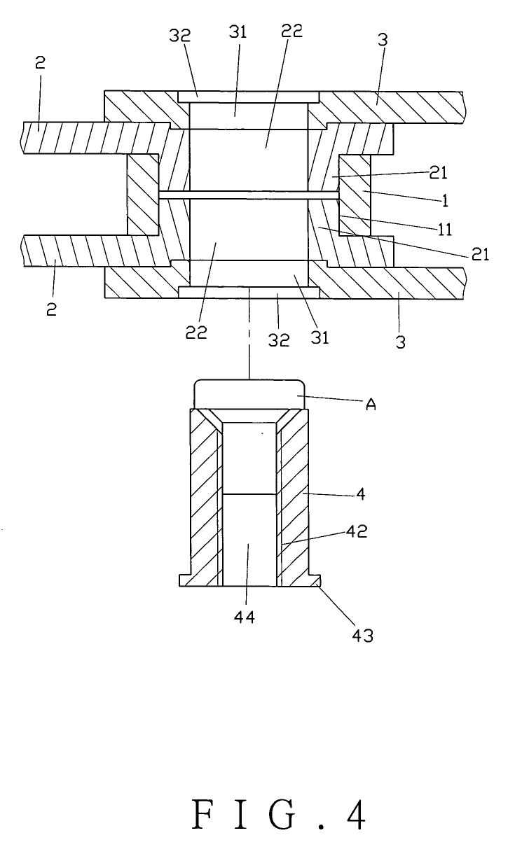

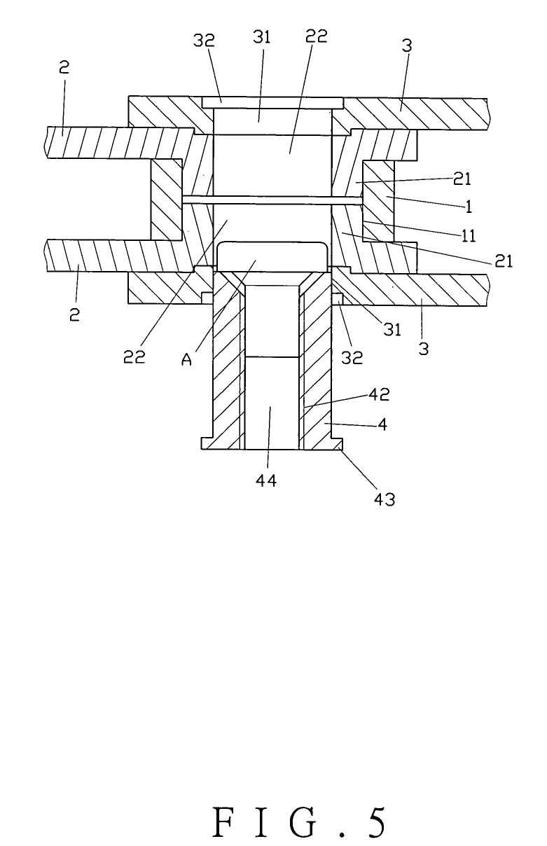

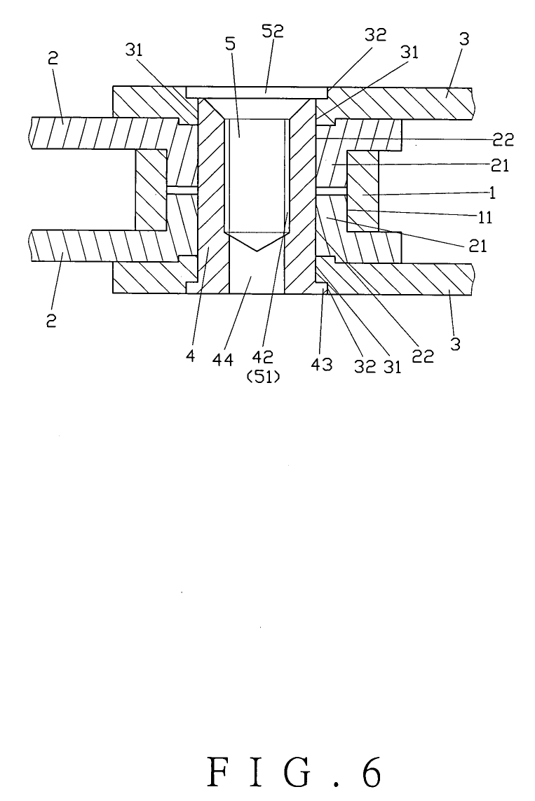

FIG. 3 shows a second embodiment of the present invention, which drills the blind hole 41 of the rivet 4 to make a through hole 44. This design facilitates disengagement of the chain to change the length or to replace broken parts. By unthreading the fastener 5 and pulling the roller 1, the inner chain plates 2 and the outer chain plates 3 disengage away from the rivet 4. To engage the chain plate, as shown in FIGS. 4 and 5, a stud A is inserted into the through hole 44. The stud A has an outer diameter that is slightly smaller than the inner diameter of the hole 31 of the outer chain plate 3. It is easier to use a hammer or any other tool to knock the tab 43 to force the rivet 4 into the hole 11 of the roller 1, the holes 21 of the inner chain plates 2, and the holes 31 of the outer chain plates 3. Then, the stud A is taken away from the through hole 44 of the rivet 4 and the fastener 5 is inserted into the through hole 44 and secured therein, as shown in FIG. 6. The tab 52 of the fastener 5 and the tab 43 of the rivet 4 are seated in the enlarged sections 32, respectively. Thus, the outer chain plates 3, the inner chain plates 2 and the roller 1 are secured and the assembly is completed.

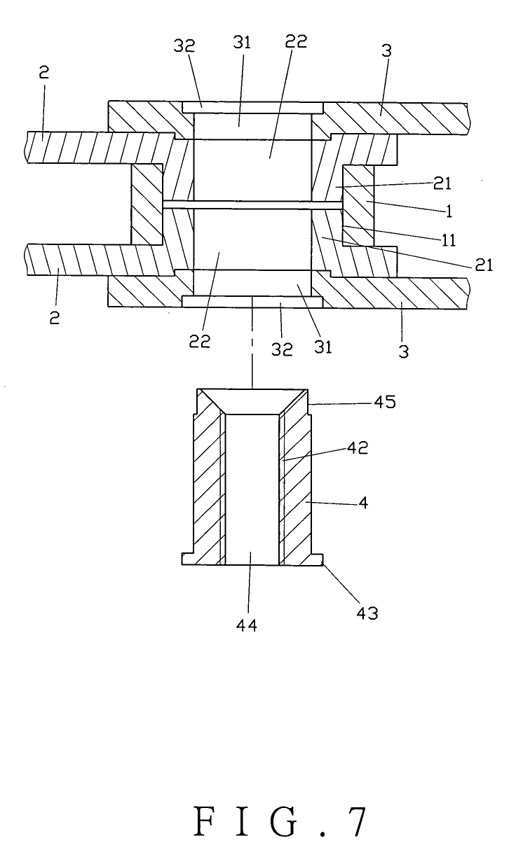

FIG. 7 shows a further embodiment of the present invention. The rivet 4 of this embodiment has a reduced section 45 at one end which is functioned as the stud A to guide the rivet 4 into the holes 31 of the outer chain plates 3, the holes 21 of the inner chain plates 2 and the hole 11 of the roller 1 and then secured by the fastener 5. This design also facilitates the engagement and disengagement of the chain.

1. A chain connecting device comprising
a roller having a hole at a center thereof;
a pair of inner chain plates pivotally connected to said roller, each inner chain plate comprising a pair of holes;
a pair of outer chain plates pivotally connected to outer edges of said inner chain plates, each outer chain plate comprising a pair of holes;
a rivet inserted through said holes of said roller, said inner chain plates and said outer chain plates, characterized by that:
further comprising a fastener, said hole of each outer chain plate comprising an enlarged section on an outer edge, and said rivet having a blind hole with inner threads therein at one end, said rivet further comprising a tab at another end, said fastener comprising a shank with threads thereon, and a tab on the end opposing said shank.

2. The chain connecting device, as recited in claim 1, wherein said blind hole of said rivet is formed in a reversed cone shape.

3. The chain connecting device, as recited in claim 1, wherein said threads of said shank of said fastener is applied with antiskid material.

4. The chain connecting device, as recited in claim 1, wherein said tab of said fastener comprises cross cut.

5. The chain connecting device, as recited in claim 1, wherein said blind hole of said rivet is drilled through to receive a stud therein.

6. The chain connecting device, as recited in claim 1, wherein said rivet comprises a reduced section at one end.
